(19) United States
(12) Patent Application Publication
(10) Pub. No.: US 2004/0162712 A1
(43) Pub. Date: Aug. 19, 2004

(54) Method for screening compounds using consensus selection

(75) Inventor: Albert M. Van Rhee, Durham, NC (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: ICAGEN, Inc., Durham, NC

(21) Appl. No.: 10/754,484

(22) Filed: Jan. 9, 2004

Related U.S. Application Data
(60) Provisional application No. 60/442,449, filed on Jan. 24, 2003.

(51) Int. Cl. G06G 7/48; G06G 7/58

(52) U.S. Cl. 703/11; 703/12

(57) ABSTRACT

A method for screening compounds for biological activity is disclosed. In one embodiment, a test library of compounds is selected. Then, a first analytical model is formed using a first recursive partitioning process using a digital computer. The first recursive partitioning process is performed on at least some of the compounds in the test library of compounds. Subsequent analytical models are formed using subsequent recursive partitioning processes using the digital computer. The subsequent recursive partitioning processes are performed on at least some of the compounds in the test library of compounds. Then, a consensus compound set is determined using the first analytical model and one or more of the subsequent analytical models.

### CROSS REFERENCE TO RELATED APPLICATIONS

This application is a non-provisional of and claims the benefit of U.S. Provisional Patent Application No. 60/442,449, filed on Jan. 24, 2003, which is herein incorporated by reference in its entirety.

### BACKGROUND OF THE INVENTION

In recent years, combinatorial chemistry coupled with high-throughput screening (HTS) has dramatically increased the number of compounds that are screened against many biological targets. Despite the resulting explosion of screening data for a given target, hit rates still tend to be quite low (typically much less than 1%). In the discovery of, for example, novel, small molecule modulators (inhibitors, activators, or otherwise) of ion channels, it would be desirable to improve hit rates beyond those obtained with historically, randomly or diversely chosen compound collections.

The application of cheminformatics to high-throughput screening (HTS) data requires the use of robust modeling methods. Robust analytical models must be able to accommodate false positive and false negative data, yet retain good explanatory and predictive power.

Recursive partitioning processes have been used to create analytical models. However, in some instances, analytical models formed using recursive partitioning suffer from high false positive rates, especially with sparse data sets such as HTS data.

Embodiments of the invention address this and other problems.

### SUMMARY OF THE INVENTION

In embodiments of the invention, consensus selection is used as a procedure to decrease the false positive rate of recursive partitioning-based models. In some embodiments, consensus selection using multiple recursive partitioning trees can increase the hit rate of a high-throughput screen in excess of 30-fold, while significantly reducing the false positive rate relative to single recursive partitioning tree models.

One embodiment of the invention is directed to a method for screening compounds for biological activity comprising: a) selecting a test library of compounds; b) forming a first analytical model using a first recursive partitioning process using a digital computer, wherein the first recursive partitioning process is performed on at least some of the compounds in the test library of compounds; c) forming a second analytical model using a second recursive partitioning process using the digital computer, wherein the second recursive partitioning process is performed on at least some of the compounds in the test library of compounds; and d) determining a consensus compound set using at least the first analytical model and the second analytical model.

Another embodiment of the invention is directed to a computer readable medium comprising: a) code for selecting a test library of compounds; b) code for forming a first analytical model using a first recursive partitioning process using a digital computer, wherein the first recursive partitioning process is performed on at least some of the compounds in the test library of compounds; c) code for forming a second analytical model using a second recursive partitioning process using the digital computer, wherein the second recursive partitioning process is performed on at least some of the compounds in the test library of compounds; and d) code for determining a consensus compound set using at least the first analytical model and the second analytical model.

The present application refers to the use of first, second, third and fourth analytical models for purposes of illustration. It is understood that the use of these terms does not limit the invention to exactly two, three, four, etc. analytical models. Some embodiments may use two or more analytical models, while other embodiments could use tens or even hundreds of analytical models in a consensus selection process.

These and other embodiments of the invention are described in further detail below.

### BRIEF DESCRIPTION OF THE DRAWINGS

FIG. 1 shows a flowchart illustrating a method according to an embodiment of the invention.

FIG. 2 shows a flowchart for some steps used in forming a recursive partitioning tree.

FIG. 3 shows an example of a portion of a recursive partitioning tree.

FIG. 4(a) shows a graph showing a distribution of hits in a training set and a validation set.

FIG. 4(b) shows a graph showing a distribution of hit rates in a training set and a validation set.

FIG. 5 shows Table I showing the effect of variations in tree depth (TD), maximum knots (max. knots), and minimum samples (min. samples).

FIG. 6 shows Table II showing consensus selection using multiple recursive partitioning trees.

FIG. 7 shows Table III showing consensus selection as it is applied to compounds that have been screened using a high throughput screening process.

FIG. 8 shows Table IV with consensus selection as applied to a validation set.

### DETAILED DESCRIPTION

Recursive partitioning is a method whereby a group of samples (e.g., compounds) is recursively split at a branch point into two statistically distinct nodes. The data matrix consists of columns for each of the descriptors, and rows for each of the samples of a training set. Each descriptor column is subjected to a process called splitting, in which a range for a descriptor is split into subranges. By systematically varying the splitting process, the statistical significance of each descriptor and its correlated range is determined. Branch points (or nodes) are identified by systematically evaluating the data matrix for the possibility to divide the matrix into statistically differentiated subsets based on their assigned category. The statistically most significant split then becomes a branch point in the recursive partitioning tree. Each subset in the matrix is subsequently analyzed for further significant differentiation. The process ends either when there are no more significant splits to be obtained, or when the minimum number of samples per node is reached. Once a recursive partitioning tree is formed, it may then be desirable to prune the tree to the appropriate tree depth as defined at the outset of the process. Additional details about screening processes using recursive partitioning can be found in U.S. patent application Ser. No. 60/270,365 filed Feb. 20, 2001, and U.S. patent application Ser. No. 10/077,358, filed Feb. 15, 2002. Both of these patent applications are herein incorporated by reference in their entirety.

There are several measures for determining the success of a recursive partitioning analysis. Some measures for determining success are as follows:

“hit rate” refers to the number of compounds that are shown to have biological activity within a predetermined activity range expressed as a percentage of the number of compounds in a set of compounds being analyzed. The pre-determined cut-off may be determined in any suitable manner. For example, the “hit rate” for a model formed using a training set of compounds may be the percent of compounds classified as “highly active” by the model. The “hit rate” for a training set of compounds as empirically determined may be the percent of compounds that are classified as being “highly active” after the compounds are tested, and are confirmed as being highly active. The bounds of “highly active” can be determined by one of ordinary skill in the art.

“fold enrichment” is the hit rate predicted by a model divided by the hit rate of an entire training set as empirically determined.

“% class correct” is a measure of the number of compounds correctly predicted to be within a predetermined range of activity (e.g., “highly active”) as a percentage of the total number of compounds in the set known to be within the predetermined activity range.

“% overall correct” is the total number of compounds, regardless of class, correctly classified by the model, i.e., the sum of all true positive and true negative assignments, expressed as a percentage of the entire training set.

It is relatively easy to obtain a high % overall correct by simply classifying all compounds as inactive, or to obtain a high % class correct by classifying all compounds as active, but it is much harder to obtain a high % class correct and fold enrichment while maintaining a high % overall correct.

Sometimes, a molecule is included in a node because one of its descriptors increases the probability for it to be classified as “highly active.” If this molecule, by virtue of its measured activity, belongs to a class other than the one to which it has been assigned, then that molecule is a “false positive” within that node. This, at times, occurs with a series of similar (congeneric) compounds. Conversely, molecules may have been eliminated from a node based on dissimilarity, but should have been included. These molecules are “false negatives.” Statistical models desirably try to minimize both the number of false negatives and false positives.

The false positive (i.e., the percentage of compounds identified by the model as having a high probability of being active, but not actually having demonstrable activity) and false negative (i.e. the percentage of compounds identified by the model as having a low probability of being active, but actually having demonstrated activity) rates are better indicators of overall model quality. Whereas it is virtually impossible to evaluate the false negative rate of any model without experimentally testing all possible compounds, it is feasible to evaluate the impact of model input parameters on the false positive rate.

While the role of molecular diversity and the influence of false positive data on interpretation of HTS screening results has been the subject of much speculation, most computational methods described to date utilize confirmed data from compound collections that tend to be poorly diverse. On the one hand, the level of diversity in a screening set can be highly controlled. On the other hand, HTS data by their nature are unconfirmed, and will contain some level of false positive and false negative data. It would be desirable to develop a method that is sufficiently robust to accommodate false positives and false negatives without compromising the utility of the models. To address this problem, consensus selection can be used with multiple recursive partitioning trees to identify consensus sets of compounds.

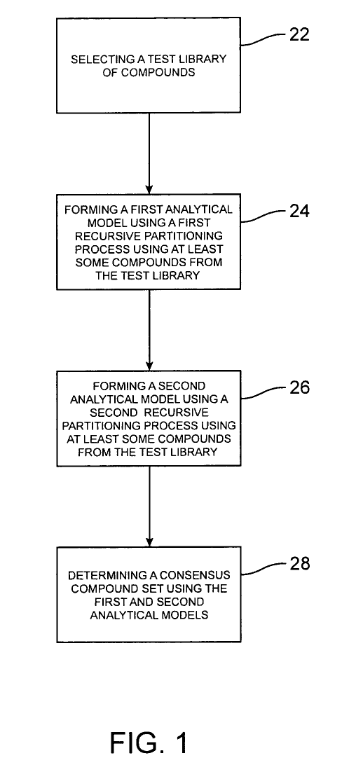

FIG. 1 shows a method according to an embodiment of the invention. In the illustrated method, a test library of compounds is selected (step 22). After a test library of compounds is selected, a first analytical model is formed using a first recursive partitioning process using a digital computer (step 24). The first recursive partitioning process is performed on at least some of the compounds in the test library of compounds. For example, the compounds that are processed with the first recursive partitioning process may be a training set of compounds. Concurrently with, or after the formation of the first recursive partitioning process, a second analytical model is formed using a second recursive partitioning process using the digital computer (step 26). The second recursive partitioning process is performed on at least some of the compounds in the test library of compounds. The compounds used to form the second analytical model may be the previously mentioned training set of compounds or another set of compounds from the test library.

The first and second analytical models may respectively be two or more different recursive partitioning trees. The first and second analytical models may be, respectively, first and second recursive partitioning trees that are formed using the same or different set of compounds. The first and second recursive partitioning processes may be the same or different. For example, in some embodiments, the first and second analytical models may be formed using respectively different sets of parameters (e.g., tree depth, maximum knots, minimum number of samples per node, etc.), but may use the same training set of compounds. In another example, the parameters used to form the first and second analytical models may be the same (e.g., the same tree depth, maximum knots, and minimum number of samples per node), but the set of compounds used to form the first and second analytical models may be different. In these instances, different recursive partitioning trees are formed and these can be used to form a consensus model, which can be used to identify a consensus set of compounds.

A consensus compound set is then determined using the first analytical model and the second analytical model (step 28). As explained in further detail below, the Boolean intersection of two or more models can be used to identify the consensus compound set. Although the use of two analytical models is discussed for purposes of illustration, it is understood that more than two models can be used to form the consensus set of compounds.

### I. Selecting a Test Library of Compounds

For each analytical model, a test library of compounds may be identified. In some embodiments, the test library has a high information content (i.e., it can be maximally diverse within the relevant pharmaceutical and/or therapeutic diversity space). The test library may contain any suitable type of compound and any suitable information that is related to the compounds. For example, the compounds in the test library may be chemical compounds or biological compounds such as polypeptides. The test library may contain data relating to the compounds in the test library. For example, each compound in the test library may have chemical data such as a hydrophobic index and a molecular weight associated with it. The test library including the compounds and the information related to the compounds may be stored in a database.

The compounds in the test library may be obtained in any suitable manner. For example, the compounds in the test library may be selected from a pre-existing set of compounds. Alternatively or additionally, the compound library may contain compounds that have been created in a synthesis process such as a combinatorial synthesis process. The test library of compounds may be synthesized either by solid or by liquid phase parallel methods known in the art. The combinatorial process can be directed by synthetic feasibility without prior knowledge of the biological target. Additionally, compounds may only exist in a virtual sense (i.e. in an electronic form stored on a hard drive or in memory in a computer), such that the compounds' characteristics can be calculated and/or predicted without the compounds being physically present. Selected candidate (second or third tier) molecules can then undergo actual synthesis and testing.

Illustratively, a new compound data set consisting of 15,000 compounds can be created using, for example, combinatorial synthesis. The new compound data set can be compared to a pre-existing data set stored in a database such as an Oracle™ relational database management system. The relational database management system may store numeric data, alphanumeric data, binary data (such as in e.g., image files), chemical data, biological activity data, analytical models, etc. Members of the new compound data set that are not redundant of the pre-existing compound data set can then be retained and added to the database containing the pre-existing compound data set. The compound data set thus defined forms the testing library.

A commercial software package such as ISIS™ (Integrated Scientific Information System—a commercially available client/server application from MDL™ Information Systems, Inc., San Leandro, Calif.) can be used to compare data sets. ISIS™ can interface with, e.g., an Oracle™ database to allow for the searching of, for example, chemical data and structures stored in the Oracle™ database. ISIS™ allows a user to compare two compound data sets and determine the overlap (redundancy) between the data sets. Moreover, it allows the registration of redundant non-structure related data into the database while retaining only unique structure information. Of course, in other embodiments, data sets of compounds need not be compared to form a test set. For example, a number of compounds can be formed by a combinatorial synthesis process and then may be characterized. The compounds may form a test set without comparing the newly formed compounds with a pre-existing compound data set.

After forming the test library, some or all of the members of the compounds in the test library may be evaluated according to a predetermined pharmaceutical or a therapeutic profile. The evaluation can be conducted using, for example, Sybyl™, a commercially available molecular modeling suite of programs from Tripos, Inc., St. Louis, Mo. Using Sybyl™, 2D structural information can be transformed into 3D coordinates, and physicochemical properties based on either 2D or 3D chemical information can be obtained. 2D or 3D information can be used to determine if a compound is to be assigned a particular pharmaceutical or therapeutic profile. Using the pharmaceutical or therapeutic profile, only those compounds that fit the profile may be selected, and compounds that do not fit the profile are excluded, thus reducing the number of potential candidates. The selection of compounds using the pharmaceutical or therapeutic profile can take place before or after the analytical model is formed.

A typical pharmaceutical profile includes characteristics that make a compound desirable as a pharmaceutical agent. For example, one characteristic of a pharmaceutical profile may be the ability of a compound to dissolve in a liquid. If a compound dissolves in such liquid, then the compound fits the pharmaceutical profile. If it does not, then it does not fit the pharmaceutical profile. A typical therapeutic profile includes characteristics that make a compound desirable for a particular therapeutic purposes. For example, if the particular therapeutic purpose is to provide therapy to the brain, then the compound may have characteristics (e.g., small size) that permit it to pass the blood-brain barrier in a person. If the compound has these characteristics, then it fits the therapeutic profile. Characteristics relating to the pharmaceutical or therapeutic profile may be present in the test library and may be stored in a database along with each of the compounds in the test library. At any point, the profile information may be used to select compounds that have a higher likelihood of exhibiting a predetermined biological activity and/or are suitable for the particular pharmaceutical or therapeutic goal in mind.

### A. Test Set and Training Set Selection from the Library of Compounds

A test set of compounds and a training set of compounds are selected from the test library of compounds. Typically, the number of compounds in the training set is less than 20% of the number of compounds in the test set. After the training set is formed, the test set may be the remaining compounds in the test library. For example, a test library may contain 700,000 molecules and the formed training set may consist of 15,000 molecules. The test set may then consist of the remaining 685,000 molecules.

The information content of the training set, whether a combinatorial library candidate for HTS or a statistical analysis data set, influences the efficiency and/or utility of the analysis methodology. For this reason different experimental design strategies have been developed for diverse compound selection from a larger chemical library or chemical diversity space. (Hassan, M. et al., Mol. Diversity, 2:64-74 (1996); Higgs, R. E. et al., J Chem. Inf. Comput. Sci., 37:861-870 (1997).

In some embodiments, a diverse selection (DS) process can be performed using a D-optimal design strategy (Euclidian distance metric, Tanimoto Similarity Coefficient, 10,000 Monte Carlo Steps at 300 K, with a Monte Carlo Seed of 11122, and termination after 1,000 idle steps), as implemented in Cerius²™ (version 4.0; Accelrys Inc., San Diego, Calif.). In a DS process, compounds are selected to maximize representation in the test library. For example, if the compounds have characteristics that make them cluster in some way (e.g., by similar morphology), then fewer compounds in the cluster are selected in order to increase the representation of other compounds in the training set.

In other embodiments, a diverse selection of 5,000 compounds was randomized with regard to the biological activity, yielding a diverse/randomized (DR) training set. The compounds in the diverse/randomized (DR) training set are randomly assigned biological activities, and a model is created. If the created model does not perform well, then the selected training set is desirable since the biological activities were randomly assigned and were not derived from actual testing. For example, 10 independent rounds of randomization can be performed where compounds are randomly (using a random number generator) assigned to the activity bins proportionately to their initial distribution, but without regard to their chemical structure and their measured biological activity.

In other embodiments, a random (RS) selection process can be used to form the training set. A training set formed by a random selection process is a stochastic sampling of a complete library, and therefore represents the information content in proportion to its distribution in the test library. In a sense, the information content is lower in a training set formed by random selection than by diverse selection. In a random selection process, densely populated areas with repetitive information are sampled more frequently than sparsely populated areas containing unique information.

### II. Assaying

The compounds in the training set may be assayed to determine their biological activity. In some embodiments, an ion channel assay may constitute a homomultimeric, or heteromultimeric isoform of a single ion channel, or multiple ion channels related through their gene sequence (i.e., a “gene family”). If an assay constituting a homomultimeric or heteromultimeric ion channel of the same gene family is used, it is possible to establish a “gene family library space” by intersecting the screening results for different ion channel types (i.e., intersecting models). A “gene family library space” refers to a library consisting of compounds that work against more than one type of ion channel. For example, compounds in a gene family library space may work against two or more types of ion channels. A “gene specific library space” may be formed by subtracting the results of different screening results for different ion channel types (i.e., differentiating models). A “gene specific library space” refers to a library consisting of compounds that work preferentially against one type of ion channel.

Ion channels are membrane embedded proteins of multimeric composition with intrinsic ion conduction properties. The intended pharmacological endpoint, i.e. activation, prolongation of activation, termination of activation, or block of the target ion channel, is dependent on the site and mode of binding of the ligand to the channel. The limitation of most Quantitative Structure-Activity Relationship (QSAR) methods is that a single (quasi-) linear equation is presumed to account for all biological activity, which is presumed to reside in a single binding site. Whereas this may hold true for selective, reversible, and competitive binding models, these conditions need not necessarily apply to HTS data sets. Furthermore, past research here and elsewhere (see Holzgrabe, U., Mohr, K. Allosteric Modulators of Ligand Binding to Muscarinic Acetylcholine Receptors. Drug Disc. Today 1998, 5, 214-222, Zwart, R., Vijverberg, H. P. Potentiation and Inhibition of Neuronal Nicotinic Receptors by Atropine: Competitive and Noncompetitive Effects. Mol. Pharmacol. 1997, 52, 886-895, Chen, H. S., Liptin, S. A. Mechanism of Memantine Block of NMDA-activated Channels in Rat Retinal Ganglion Cells: Uncompetitive Antagonism. J. Physiol. 1997, 499 (Pt 1), 27-46) indicates that it is very likely that many chemical modulators of ion channels, especially those that are endogenously regulated by membrane potentials (e.g., the Kᵥ gene family) or ion concentrations (e.g., Ca²⁺-sensitive channels), are noncompetitive, or uncompetitive, allosteric modulators. It was previously demonstrated that this problem can be addressed using Probabilistic Structure-Activity Relationship (PSAR) models based on Recursive Partitioning. (van Rhee, A. M., Stocker, J., Printzenhoff, D., Creech, C., Wagoner, P. K., Spear, K. L. Retrospective Analysis of an Experimental High-Throughput Screening Data Set by Recursive Partitioning. J. Combi. Chem. 2001, 3, 267-277.)

The biological activities determined by the assaying process may be defined by two or more classes (e.g., high activity and low activity). Preferably, the biological activities may be defined by three or more related classes (e.g., high activity, moderate activity, and low activity). For example, the screening assay determines the biological activity of each compound. Each compound is then assigned to a particular class with a predetermined activity range, based on the determined biological activity. In some embodiments, the activity ranges for the different classes may include “high activity”, “moderate activity”, “low activity”, and “inactive.” The skilled artisan can determine the quantitative bounds of the classes.

Any suitable assay known in the art may be used to determine the biological activity of the compounds in the test library. For example, the biological activity of the compounds may be determined using a high-throughput whole cell-based assay.

In preferred embodiments, the assay determines the ability of the compounds in the test set to modulate the activity of ion channels and the degree of activity. For example, the activity of an ion channel can be assessed using a variety of in vitro and in vivo assays, e.g., measuring current, measuring membrane potential, measuring ligand binding, measuring ion flux, (e.g., potassium, or rubidium), measuring ion concentration, measuring second messengers and transcription levels, using potassium-dependent yeast growth assays, and using, e.g., voltage-sensitive dyes, ion-concentration sensitive dyes such as potassium sensitive dyes, radioactive tracers, and electrophysiology. In a specific example, changes in ion flux may be assessed by determining changes in polarization (i.e., electrical potential) of the cell or membrane expressing the ion channel. A preferred means to determine changes in cellular polarization is by measuring changes in current (thereby measuring changes in polarization) with voltage-clamp and patch-clamp techniques, e.g., the “cell-attached” mode, the “inside-out” mode, and the “whole cell” mode (see, e.g., Ackerman et al., New Engl. J. Med. 336:1575-1595 (1997)). Whole cell currents are conveniently determined using the standard methodology (see, e.g., Hamil et al., Pflügers. Archiv. 391:85 (1981).

In an illustrative assay for a potassium channel, samples that are treated with potential potassium channel modulators are compared to control samples without the potential modulators, to examine the extent of modulation. Control samples (untreated with activators or inhibitors) are assigned a relative potassium channel activity value of 100. Modulation is achieved when the potassium channel activity value relative to the control is distinguishable from the control. The degree of activity relative to the control is generally defined in terms of the number of standard deviations from the mean. For instance, if the mean is 0%, and the standard deviation is 25%, then the activity ranges could be defined as 1) 0-25%, i.e. within 1 standard deviation of the mean, 2) 25-50%, i.e. within 2 standard deviations from the mean, 3) 50-75%, i.e. within 3 standard deviations from the mean, and 4) 75-100%, i.e. within 4 standard deviations from the mean. These ranges of activity may correspond to, for example, inactive, weakly active, moderately active, and highly active, respectively.

### III. Forming First, Second, Third and Subsequent Analytical Models

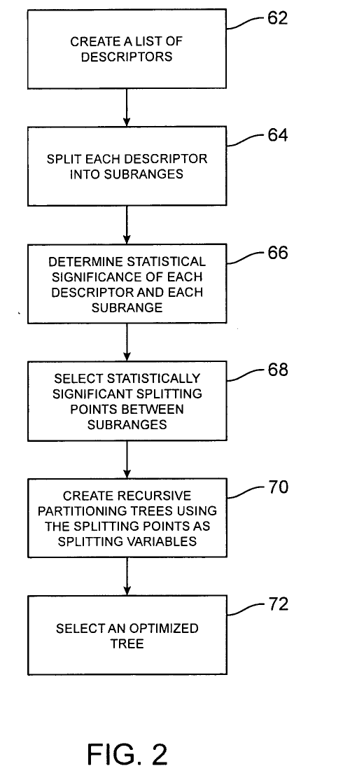

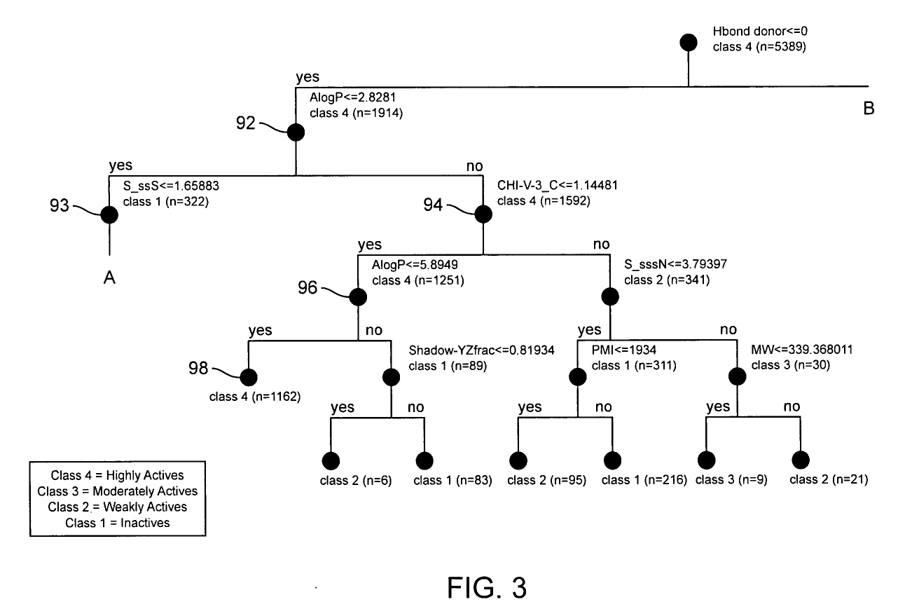

In one embodiment of the invention, two or more recursive partitioning trees may be formed from at least some of the compounds in the test library. The same or different sets of compounds may be used to form the different recursive partitioning trees. If the same sets of compounds are used, then the parameters used to form the trees may differ in some way. For example, the tree depth and/or the minimum samples per node may be varied to produce different recursive partitioning trees using the same set of compounds. Alternatively, different sets of compounds from a test library may be used to form respectively different recursive partitioning trees. Exemplary processes for forming recursive partitioning trees can be described with reference to FIGS. 2 and 3.

Referring to FIG. 2, a list of descriptors is created to form a descriptor space (step 62). A descriptor may be binary in nature, i.e., it can denote the presence or absence of a feature but not its extent. For example, a descriptor named “heterocyclic” may denote the presence (1) or absence (0) of heteroatoms in a ring otherwise constituted by carbon atoms, but holds no information as to the number of heteroatoms present. Alternatively, a descriptor could be a continuous range descriptor. That is, it can denote the extent to which a particular feature is represented. For example, the molecular weight of a compound may be considered a continuous range descriptor. All molecules have a molecular weight, but the extent of the descriptor (e.g., a molecular weight as expressed in a range of Daltons) can be used to discriminate one molecule from another. Other examples of descriptors include the principal moment of inertia in a molecule's primary X-axis (PMI_X), a partial positive surface area (JURS_PPSA_{—}1), molecular density (Density), molecular flexibility index (phi), etc. In embodiments of the invention, hundreds or thousands of such descriptors can be considered when forming an analytical model.

A number of exemplary descriptors are provided in Cerius²™, commercially available from Accelrys, Inc., San Diego, Calif. Cerius²™ is capable of generating descriptors such as spatial descriptors, structural descriptors, etc. for evaluation. It is also capable of creating recursive partitioning trees. It also allows for the variation of variables such as knot limit, tree depth, and splitting method. In embodiments of the invention, the tree depths of the recursive partitioning trees created are systematically varied until the optimal tree(s) are determined.

Each descriptor is subjected to a process called splitting, in which the range (highest descriptor value minus lowest descriptor value) is split into subranges (step 64). By systematically varying the splitting process, the statistical significance of each descriptor and its correlated range is determined (step 66). Splitting points are identified by systematically evaluating the subranges for the possibility to divide the compounds into statistically differentiated subsets based on their assigned category (step 68). The statistically most significant splitting point then becomes a splitting variable in the recursive partitioning tree.

Illustratively, a descriptor such as molecular weight can be optimized. Based on past experience or knowledge, it may be determined that the molecular weight of the particular modulator being sought would have a molecular weight ranging from 23 to 20,000. The range of 23-20,000 can then be split into progressively smaller subranges. The training set data are then applied to these splits to determine which subrange is the optimal range. For example, if it is discovered that out of 200 candidate compounds, 50 compounds having a molecular weight between 23-10,000 exhibit high activity and 150 compounds having a molecular weight between 10,000 and 20,000 exhibit low activity, then the range of 23-10,000 is selected as the more preferred range. Since a molecular weight of 10,000 splits the data, it is a splitting point and may be referred to as a “knot”. “Splitting points” and “knots” are used interchangeably and refer to values that are used to split a range for a descriptor. The 23-10,000 molecular weight continuous range descriptor is then used as a splitting variable at a node in a classification and regression tree. For example, the variable MW (molecular weight) could be used in two consecutive splits: MW<=10,000 and MW>23, to define the preferred range of 23-10,000 used to classify compounds in the test set. In this example, only one descriptor with two knots is described for simplicity of illustration. However, in other embodiments, the number of knots per descriptor may be 2 to 140 or more. Narrow or broad ranges for the descriptors can be evaluated for statistical significance.

### A. Forming Trees

A plurality of recursive partitioning trees is created (step 70). Tens or hundreds of trees may be generated in some embodiments. Each tree uses the descriptors, as calculated and optimized above, as splitting variables to form splits in the data. Many such trees are created while varying such parameters as the knot limit, tree depth, and splitting method. Then, an optimal tree is selected (step 72) as an analytical model. The most desirable tree found is the one that differentiates the data the best according to biological activity. The most desirable tree may be a first analytical model. The same general process may be repeated to form a second, third, and subsequent analytical model.

In a typical recursive partitioning tree, parent nodes are split into two child nodes. A splitting variable splits the training set compounds into two statistically significant groups, and these two groups are classified into two respective child nodes. A Student's t-test may be used to determine the statistical significance of the split. In forming a tree, splitting methods such as the Gini Impurity, Twoing Rule, or the Greedy Improvement can be used to split the compounds. These methods are well known in the art and need not be described in further detail here (see: Breiman, L., Friedman, J. H., Olshen, R. A., Stone, C. J. Classification and Regression Trees, Wadsworth (1984)).

Once a best split is found, the classification and regression tree process repeats the search process for each child node, continuing recursively until further splitting is impossible or stopped. Splitting is impossible if only one case remains in a particular node or if all the cases in that node are of the same type. Alternatively, the process ends when there are either no more significant splits to be obtained, or when the minimum number of compounds per node is reached. The nodes at the bottom of a tree (i.e., where further splitting stops) are called terminal nodes. Once a terminal node is found, the node is classified. The nodes can be classified by, for example, a plurality rule (i.e., the group with the greatest representation determines the class assignment). The tree may be pruned to the appropriate tree depth as defined at the outset of the process.

FIG. 3 shows an example of a portion of a recursive partitioning tree. The area where the letters “A” and “B” are present would have additional nodes, branches, etc. For purposes of clarity, these additional tree structures have been omitted. In this example, a node 92 may be characterized as a highly active node where the tree initially classifies 1914 members of a test set as being highly active. Then, the splitting variable “AlogP<=2.8281” may be applied to the 1914 compounds at the node 94. “AlogP” is a property of a chemical compound that is described in greater detail in Ghose A. K. and Crippen G. M. (J. Comput. Chem., 7, 1986, 565). Compounds that satisfy this condition are placed in node 93 while compounds that do not are placed in node 94. The compounds assigned to these nodes 93, 94 are further split in a similar fashion, but with different rules. The classification of each node 93, 94 can be determined by determining which particular activity (i.e., highly active, moderately active, weakly active, or inactive) predominates at the node. The compounds can be split until a terminal node 98 is reached. In some embodiments, the terminal node may contain compounds, all of which (or a majority of) have the same biological activity. The terminal node may then be characterized by the determined biological activity. In this particular example, the nodes 92, 94, 96, 98 are all characterized as highly active nodes. The compounds classified in terminal node 98 satisfy the following conditions:

Hbond donor<=0, yes (“Hbond donor” is the number of hydrogen bond donors)

AlogP<=2.8281, no (“AlogP” is a calculated octanol/water partitioning coefficient)

CHI-V-3_C<=1.14481, yes (“CHI-V-3_C” is a 3rd Order Cluster Vertex Subgraph Count Index)

AlogP<=5.8949, yes (“AlogP” is a calculated octanol/water partitioning coefficient)

This set of rules or descriptors can be used to select a class of compounds that are expected to have a “high biological activity”. In this example, the 1162 compounds in the terminal node 98 may serve as potential candidates for modulators. If desired, these compounds may be analyzed (e.g., by a computer or the skilled artisan) to determine if there are any chemotypes that are prevalent in the terminal node compounds. These chemotypes may serve as a basis for further research or analysis. Advantageously, in embodiments of the invention, potentially effective chemotypes can be identified in addition to providing enhanced hit rates.

### IV. Determining a Consensus Set of Molecules

“Consensus selection” is a process for group decision-making. It is a method by which a group of models can be in agreement. The input and statistics of all participating models are gathered and synthesized to arrive at a final model satisfying the conditions of all contributing models. “Voting” (a.k.a. election) is a means by which one model is preferentially selected from several models by weighting the input of each of the individual models. “Consensus selection,” on the other hand, is a process of synthesizing many diverse elements together.

The consensus selection process involves the determination of the Boolean intersection of a set of models (at least 2, in theory unlimited, individually derived models), thereby emphasizing the probabilities of the consensus set, and de-emphasizing the probabilities of the contributors for each of the models excluded from the consensus set, i.e., the dissenting sets. The process is expected to have a higher chance of eliminating false positives from the process, thereby reducing operating costs, throughput requirements, and timelines, while increasing the reliability of the process. The consensus selection methodology has not been associated with probabilistic modeling methods such as recursive partitioning.

As noted above, two or more recursive partitioning trees may be formed from at least some of the compounds in the test library. The same or different sets of compounds may be used to form the different recursive partitioning trees. If the same sets of compounds are used, then the characteristics of the trees may differ in some way. For example, the tree depth and/or the minimum samples per node may be varied to produce different recursive partitioning trees using the same set of compounds. Alternatively, different sets of compounds from a test library may be used to form respectively different recursive partitioning trees.

The Boolean intersection of the results of two or more recursive partitioning trees may be used to form a consensus set. For example, a first set of compounds is identified using a first recursive partitioning tree, and a second set of compounds is identified using a second recursive partitioning tree. A consensus model may then identify compounds that are common to both the first and second sets of compounds. The compounds that are common to both the first and second sets may be identified automatically by a computer. The identified compounds can form the consensus set. As will be shown in more detail below, the number of compounds identified by the consensus model is less than the number of compounds identified by each recursive partitioning tree used to form the consensus model. The number of identified compounds and the false positive rate are reduced, while maintaining a high fold-enrichment.

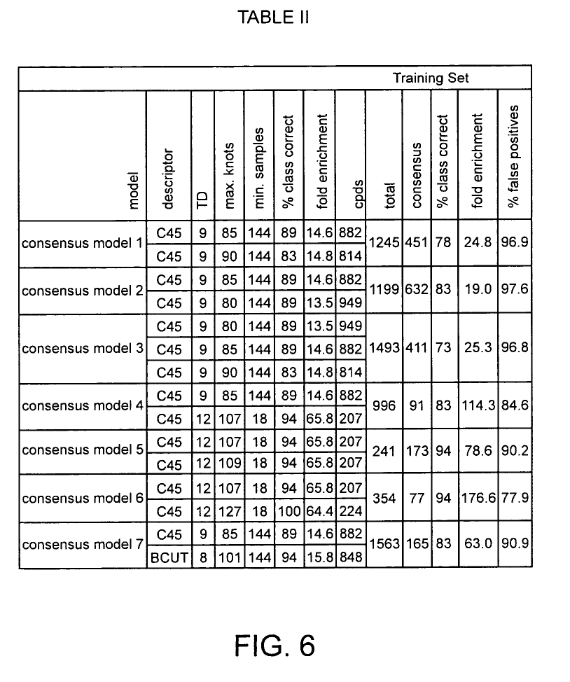

Embodiments of the invention have a number of advantages. Since the number of identified compounds is reduced using consensus selection, without increasing the false positive rate and without affecting the fold enrichment, the costs associated with discovering potentially useful compounds are reduced. For example, as discussed in further detail below (Table 2, FIG. 6), consensus model 1 was formed using two models. The first or reference model identified 882 compounds, had a 89% class correct, a 14.6-fold enrichment, and a 98.2% false positive rate. The second model had a 83% class correct, and a 14.8-fold enrichment. The consensus model 1 that was formed using the first and second analytical models, identified 451 compounds, and exhibited a 78% class correct, a 24.8-fold enrichment, and a 96.9% false positive rate. With respect to the first model, the number of compounds identified decreased from 882 to 451, while the fold enrichment increased and the false positive rate decreased. At present day cost, it may cost between about 10-55 dollars to test a single candidate compound. Embodiments of the invention can reduce the number of compounds tested by thousands or even tens of thousands. Accordingly, the cost savings that can be achieved by embodiments of the invention can be substantial.

Functions such as the selection of compounds using a therapeutic or pharmaceutical profile, the creation of the first and second analytical models (i.e., the creation of descriptors or trees, and the optimization and/or selection of models), the application of the analytical model to a test set, the determination of a consensus set, etc., can be performed using a digital computer that executes code embodying these and other functions. The code may be stored on any suitable computer readable media. Examples of computer readable media include magnetic, electronic, or optical disks, tapes, sticks, chips, etc. The code may also be written in any suitable computer programming language including, C, C++, etc. The software modules may be written in a software development environment such as SPL, SQL and/or C2*SDK, the shell (e.g., the C-shell or Korn shell) environment, or the programming language relevant to the particular application program being used.

The digital computer used in embodiments of the invention may be a micro, mini or large frame computer using any standard or specialized operating system such as a UNIX, or Windows™ based operating system. It is understood that the digital computer that is used in embodiments of the invention could be one or more computational apparatuses that may be together or spatially separated from each other, and may operate using any suitable computer code.

Moreover, any suitable computer database may be used to store any data relating to the test library, test set, training set, or analytical models. Preferably, a computer database such as an Oracle™ relational database management system is used to store this information.

### IV. EXAMPLES

A database of commercially available compounds was maintained, and certain “pharmaceutically-relevant” selection criteria (such as a molecular weight cut-off of 500, a ClogP cut-off of 5, toxicity and chemical reactivity indicators, etc.) were applied to the compounds. Only those compounds passing all of the criteria were considered “HTS Eligible.” The size of the collection was in constant flux, and contained about 2 million compounds.

383 descriptors were calculated using Cerius² (version 4.5; Accelrys Inc., San Diego, Calif. They were selected from the following categories: E-state keys, Electronic, Information Content, Molecular Shape Analysis, Spatial, Structural, Thermodynamic, and Topological). Another 72 descriptors were calculated using Diverse Solutions (version 4.06; Tripos Inc, St. Louis, Mo.; BCUT descriptors with explicit hydrogens).

A training set (15,000 compounds targeted, 14,431 compounds obtained from then available stock of the following vendors: ChemDiv Inc, San Diego, Calif, Tripos Inc., St. Louis, Mo., ChemBridge Inc., San Diego, Calif., and AsInEx Inc., Moscow, Russia) was designed using a diverse compound selection process through a D-optimal Design strategy (Euclidian distance metric, Ochiai Similarity Coefficient, Mean/Variance Normalization, 75,000 Monte Carlo Steps at 300 K, with a Monte Carlo Seed of 12379, termination after 1,000 idle steps, a Gaussian alpha of 1.0, a bucket size of 21 for the K-d tree, and taking the nearest 7 neighbors into consideration), as implemented in Cerius².

The training set was subsequently submitted to a high-throughput screening (HTS) procedure. Although a specific screening procedure was used, it is understood that any suitable high-throughput screening procedure could be used in embodiments of the invention.

A method optimization and evaluation protocol was written that varied the recursive partitioning conditions, as implemented in Cerius², systematically. The following parameters were considered: Weighting by Classes (not varied), i.e., each class is considered of equal importance to the model rather than each compound; Splitting Method: Twoing (not varied), i.e., the formalism that determines how groups are divided or partitioned into statistically distinct nodes or subgroups; maximum tree depth (TD)—5 through 16, i.e., the maximum number of splits that may occur before the partitioning process terminates; Pruning: Moderate (not varied), i.e., the procedure that determines the appropriate statistically significant tree depth for each node; minimum number of samples per node (SAMPLS)=144 (1%), 90, 54, 18, 3, and 1, i.e., a node or subgroup cannot contain fewer than this number of compounds from the training set; and the maximum number of knots per split (KNOTS)—systematically varied in increments of 5 starting at 5 and terminating at 200, or systematically varied using prime numbers starting at 2 and terminating at 199, i.e., the maximum number of ways a descriptor range may be divided before statistical relevance is determined.

### HTS Results.

The HTS procedure yielded 6 “highly active” compounds, which were assigned an activity class of 4, 12 “moderately active” compounds, which were assigned an activity class of 3, 19 “weakly active” compounds, which were assigned an activity class of 2, and 14,395 “inactive” compounds, which were assigned an activity class of 1. These results represent a 0.042% hit rate for the “highly active” compounds, and a 0.125% hit rate for the “highly active” and “moderately active” compounds combined.

### Model Validation

A recursion forest of recursive partitioning trees was generated using the optimization protocol. A reference model was selected from the recursion forest based on the criteria previously described (van Rhee, A. M., Stocker, J., Printzenhoff, D., Creech, C., Wagoner, P. K., Spear, K. L. Retrospective Analysis of an Experimental High-Throughput Screening Data Set by Recursive Partitioning. J. Combi. Chem. 2001, 3, 267-277). The reference model (TD=9, KNOTS=85, SAMPLS=1%) predicted an 89% class correct and a 14.6-fold enrichment. By collecting all samples from terminal nodes with a class assignment of “3” or “4”, 882 compounds were predicted to have an increased probability of being active. This represents a (882−16/882) or 98.2% false positive rate, and a 1.816% hit rate.

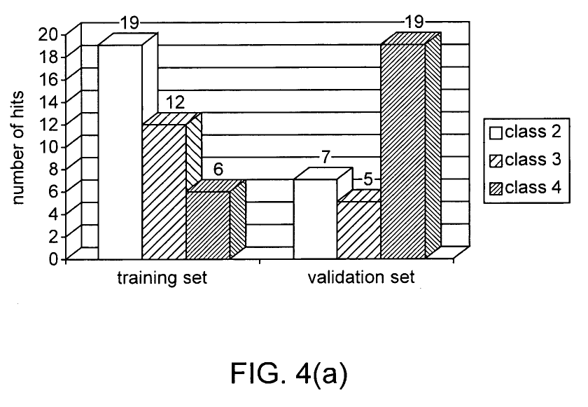

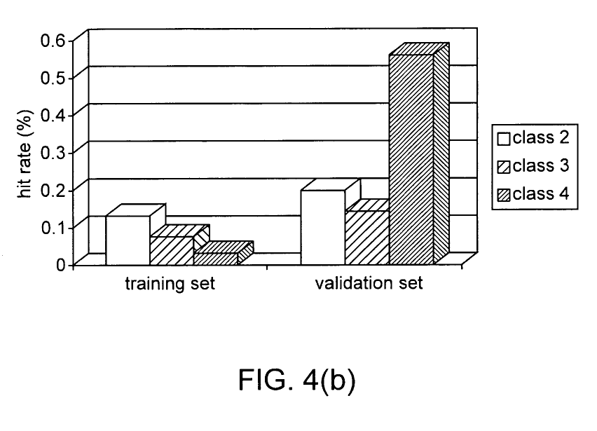

An additional set of 3,417 compounds (pharmaceutically-relevant exclusion criteria were also applied) was purchased. These compounds formed a validation set. These compounds were submitted to the same HTS procedure as the training set, and an additional 19 compounds were identified as “highly active,” an additional 5 compounds were identified as “moderately active,” and an additional 7 compounds were identified as “weakly active” (FIG. 4(a)). These results represent a hit rate of 0.556% for the “highly active” compounds, and a 0.702% hit rate for the “highly active” and “moderately active” compounds combined. The realized enrichment for this experiment was therefore 13.3-fold for the “highly active” compounds, and 5.6-fold for the “highly active” and “moderately active” compounds combined (FIG. 4(b)). The obtained fold enrichment of 13.3 is slightly lower than, but in general agreement with, the predicted fold enrichment of 14.6. Additionally, whereas fewer than 50% of the hits in the training set belong to either the “highly active” or “moderately active” categories, 77% of all hits in the validation set do.

### Sampling Rate

The complexity of a recursive partitioning tree can be thought of in terms of the following equation:

Complexity=(TD×KNOTS)/SAMPLS (Eq. 1)

The level of complexity of recursive partitioning trees increases with increasing tree depth (TD), or with an increase in the maximum number of knots (KNOTS), but decreases with larger samples size (SAMPLS).

The default for SAMPLS in the Cerius² program is 1%, or in the present case, 144 samples. Since the maximum number of“highly active”, i.e., class 4, samples that could possibly be put in one terminal node is 6, the training set was oversampled by 24-fold, which limits the number of false positives to a minimum of 138 samples per node. This is at least a 95.8% false positive rate.

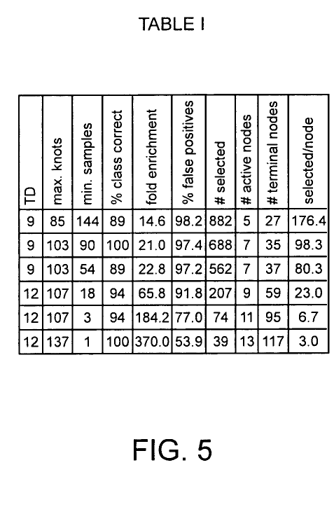

In order to split a node, 2×144=288 samples are required per node in this example. In the model described above, the number of samples per node varied between 145 and 237, which indicates that the recursive partitioning run was likely terminated because the SAMPLS criteria were reached. If the criteria are lowered, a larger and more complex tree can be grown, which theoretically should result in a lower false positive rate. The effects of changes to the SAMPLS criteria are shown in Table I (FIG. 5).

Unlike the situation where model complexity increases only as a function of tree depth (see van Rhee, A. M., Stocker, J., Printzenhoff, D., Creech, C., Wagoner, P. K., Spear, K. L. Retrospective Analysis of an Experimental High-Throughput Screening Data Set by Recursive Partitioning. J. Combi. Chem. 2001, 3, 267-277), the present inventor found that when the number of false positives decreases as a function of the minimum node size, the % class correct does not necessarily decrease (Table I, FIG. 5). However, decreasing the minimum node size does tend to slightly increase the number of knots required, as well as requiring greater tree depth to achieve stability. It therefore appears that the effect of smaller minimum node size negates the effect of the greater tree depth. Consequently, a more complex model results in more terminal nodes, and more active terminal nodes (See Table I, FIG. 5). As the false positive rate goes down, so does the number of compounds selected per node, and a more complex model also results in fewer actives per active node. In the more extreme cases the situation becomes similar to the use of the Gini method for building recursive partitioning trees: high node purity biases the tree towards highly specific nodes with good explanatory power, but with potentially poor predictive power (i.e., the model can explain the training set with high accuracy, but does not predict compounds outside of the training set well). (Breiman, L., Friedman, J. H., Olshen, R. A., Stone, C. J. Classification and Regression Trees, Wadsworth (1984)). This is akin to overfitting in deterministic (quasi-) linear QSAR models.

Although, theoretically, it should have been possible to reduce the false positive rate to zero at a “minimum number of samples per node” of 18 or less, the results as indicated in Table I, do not necessarily bear out this possibility. As the complexity of the trees grows, so does the number of terminal nodes, and thereby the chance of undeservedly classifying compounds as active. Even at a rate of 1 sample per node, no less than a 53.9% false positive rate (Table I) is obtained.

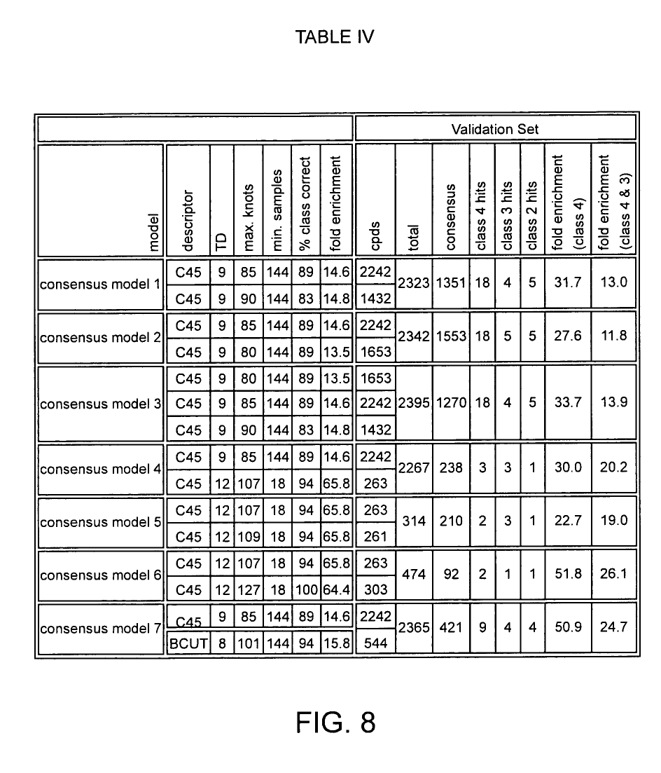

When a “minimum number of samples per node” of 18 was selected, i.e., the sum of class 4 and class 3 compounds, a recursive partitioning tree (TD=12, KNOTS=107, SAMPLS=18) could be generated predicting a 94% class correct, and a 65.8-fold enrichment. This model predicted only 263 out of the original 1,431 compounds selected for the model validation to have a high probability to be active. However, the model identified only 3 “highly active” compounds (i.e., a 1.141% hit rate) out of the original 19 present in the validation set, and an additional 3 “moderately active” compounds (i.e., a combined hit rate of 2.281%) out of the original 7 present in the validation set (See also Table IV; FIG. 8). This represents an actualized fold enrichment of 27.2 for the “highly active” compounds. Although substantially higher than the fold enrichment for the reference model, the model falls short of its own predictions. Moreover, by increasing the model stringency, 16 out of the 19 originally identified “highly active” compounds, are effectively eliminated (i.e. a false negative rate of 84.2%).

Table II (FIG. 6) shows various ways to derive models using consensus selection by recursive partitioning trees. Whereas the theorem known as “Ockham's Razor” would lead one to select a single hypothesis from among multiple hypotheses proposed, consensus selection directs one to synthesize a new hypothesis from its predecessors. This is especially useful when Ockham's Razor is hard to apply such as in situations where near-identical models yield nearly indistinguishable results. The simplest solution, in this case, is to not select a single hypothesis, but to combine useful elements from all contributing hypotheses.

Table II describes the results if models of similar complexity are paired (consensus models 1, 2, and 5), or grouped (consensus model 3) together. Table II also describes the results when models are not entirely equivalent (consensus model 6), or purposely mismatched by complexity (consensus model 4) or descriptor basis (consensus model 7). In consensus model 7, C45 and BCUT represent different descriptor matrices.

Consensus model 1 describes the Boolean intersection of the reference model, and a slightly more complex model. As can be seen in Table II, similar models behave similarly with respect to % class correct and fold enrichment. However, when consensus selection is applied, the number of compounds selected drops from 882 (TD=9, KNOTS=85, SAMPLS=144) or 814 (TD=9, KNOTS=90, SAMPLS=144) to 451, which is almost a 50% reduction in the total number of compounds selected, but translates into only a relatively small change in the false positive rate. A 50% decrease in the number of compounds selected without loss of positives, would double the fold enrichment of the process.

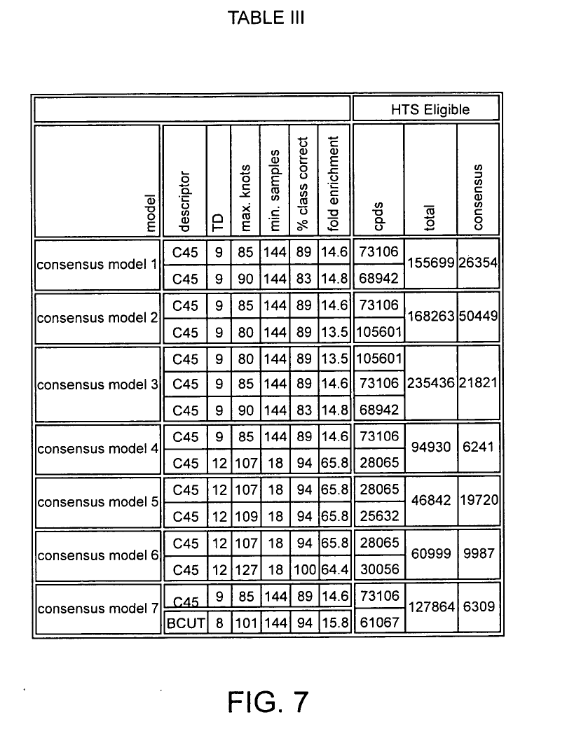

Consensus model 2 describes the Boolean intersection of the reference model, and a slightly less complex model. The less complex model itself does not meet the selection criteria outlined earlier (van Rhee, A. M., Stocker, J., Printzenhoff, D., Creech, C., Wagoner, P. K., Spear, K. L. Retrospective Analysis of an Experimental High-Throughput Screening Data Set by Recursive Partitioning. J. Combi. Chem. 2001, 3, 267-277) as it is closer (too close) to an instable region in the model optimization trace. In this case, the models match their respective % class correct, but have different outcomes for fold enrichment and the number of compounds predicted to have an increased probability of being active. Whereas the % class correct for consensus model 2 (83%) is higher than that for consensus model 1 (78%) (See Table II, FIG. 6) the number of compounds selected is reduced by 30% (Table III, FIG. 7), and without apparent effect in the validation set (Table IV, FIG. 8).

Consensus model 3 describes the Boolean intersection of the reference model, and both models of lesser and higher complexity. It is therefore expected to have a % class correct of no better than the worst performing contributing model (83%), and a fold enrichment no worse than the best performing contributing model (14.8). Indeed, consensus model 3 has a 73% class correct, and prioritizes only 411 compounds (Table II, FIG. 6). This is a 70% reduction in projected test set size (Table III, FIG. 6).

Previously, it was observed that starting with a default setting of 20 for the “maximum number of knots per split” (KNOTS) of the recursive partitioning procedure as implemented in Cerius², and incrementing the value in steps of 5, can lead to a certain periodicity in the optimization traces (van Rhee, A. M., Stocker, J., Printzenhoff, D., Creech, C., Wagoner, P. K., Spear, K. L. Retrospective Analysis of an Experimental High-Throughput Screening Data Set by Recursive Partitioning. J. Combi. Chem. 2001, 3, 267-277). This would indicate that there is an inter-relationship between such models that overrides or coincides with the splitting criteria used to obtain statistically significant splits. The procedure was changed to one using prime numbers as the KNOTS setting, and similar periodicity in the optimization traces (results not shown) was not observed. The use of prime numbers, however, limits the number of possible models within a stable region of the optimization traces, and restricts the coarseness of the internal similarity of the recursive partitioning trees, since they occur at irregular and unevenly spaced intervals.

All three consensus models described above, compare favorably to the individual contributing models when compared by the total number of compounds prioritized. In this particular case, the number of correctly identified highly active compounds is identical for all three preceding consensus selections (Table IV, FIG. 8). However, a small decrease in the number of correctly identified compounds in classes 3 and 2 can be observed (Table IV, FIG. 8).

To determine how closely related the various models need to be, in order to be effective for the consensus selection process, the Boolean intersection of two models that satisfy the selection criteria of their individual optimization traces was investigated. The first model (TD=9, KNOTS=85, SAMPLS=144), the reference model, is less complex than the second model (TD=12, KNOTS=107, SAMPLS=18) (see Table I, FIG. 5). With a high % class correct, it was not expected that the more complex model would interfere with the efficiency of the less complex model. Indeed, consensus model 4 shows a considerable decrease in the false positive rate (Table II, FIG. 6), but at the same time is only marginally better than consensus model 1, and no better than consensus model 2, with regard to % class correct.

However, the reduction in the number of compounds prioritized is substantial: up to 91% based on the less complex model, and up to 78% based on the more complex model (Table III, FIG. 7). Conversely, when the consensus model was applied to the validation set, only 3 out of 19 class 4 compounds (i.e. a false negative rate of 84.2%), and an additional 4 out of 12 class 3 or class 2 compounds, could be accurately identified. Therefore, it must be concluded that contributing models must be similar not only in their output performance characteristics, but also in their internal complexity (see Eq. 1 above).

Consensus model 5 demonstrates that higher efficiencies can be obtained by using consensus selection on higher complexity models (Table II, FIG. 6). A 94% class correct, and a 90.2% false positive rate could be obtained by selecting two similar models of higher complexity than the reference model (TD=12, KNOTS=107, SAMPLS=18, and TD=12, KNOTS=109, SAMPLS=18, respectively). The set of compounds prioritized by consensus model 5, at 19,720 compounds, is only nominally smaller than the 21,821 compounds prioritized by consensus model 3 (Table III, FIG. 7).

Consensus model 6 was created to study the impact of selecting slightly dissimilar contributing models. The second contributing model (KNOTS=127), other than the reference model (KNOTS=107), is only marginally more complex than the reference model, but exhibits an exceptionally high % class correct: 100%. As shown in Table II (FIG. 6), a high % class correct is retained in the consensus model, and a remarkable reduction in the false positive rate can be achieved. Table III (FIG. 7) indicates that a reduction of as much as 67% of the prioritized compounds, boosting the theoretical fold enrichment to about 180 fold, can be obtained under favorable circumstances. This confirms that 1. a high % class correct, and 2. small but significant divergence between recursive partitioning trees, are useful to effectively leverage consensus selection.

The final consensus model, consensus model 7, was created to investigate the contribution of the descriptor base to the consensus selection process. The reference model (TD=9, KNOTS=85, SAMPLS=144) was created using the descriptor base available in Cerius² (version 4.5), and the alternate model (TD=8, KNOTS=101, SAMPLS=144) was created using the descriptor base available through DiverseSolutions (version 4.0.6). In theory, it would be preferable to derive contributor models from independent descriptor bases, since this would eliminate bias introduced by, e.g., systematic error or descriptor type selection by a vendor, a programmer, or the optimization algorithm. In this example, two independently derived and optimized models of similar complexity were combined to address this. As is evident from Table II (FIG. 6), the contributing models behave very similar at the gross performance level, such as % class correct (89 and 94, respectively), fold enrichment (14.6 and 15.8, respectively), or number of compounds prioritized (882 and 848, respectively), and are relatively similar in terms of their internal complexity. The model still classifies 15 out of the 18 most active compounds correctly, i.e. an 83% class correct for the consensus model, whereas the false positive rate has decreased considerably to 90.9% (Table II, FIG. 6). The projection of potential utility into the HTS eligible compound collection is much better than consensus model 1, 2, or 3 of comparable complexity, and at least as good as consensus model 6 of much greater complexity (Table III, FIG. 7). However, validation of the model (Table IV, FIG. 8) results in a false negative rate of 52.6% for class 4 only, and a false negative rate of 45.8% for class 4 and class 3 combined.

The present inventor has demonstrated that recursive partitioning can be used to augment a sequential screening process. Here, it is shown that recursive partitioning sometimes exhibits a high false positive rate, and that corrections can be introduced to the recursive partitioning forest building and optimization process. Experimental evidence shows that consensus selection by using multiple recursive partitioning trees is better than using a single recursive partitioning tree when applied in the sequential screening process. The present inventor has shown that in excess of 30-fold enrichment can be obtained using this method and that better than 70% class correct can be retained, while significantly reducing the false positive rate. This leads to a reduction in the occurrence of false positives from the process, thereby reducing operating cost, and throughput requirements, shortening timelines, and increasing the reliability of the process.

The terms and expressions which have been employed herein are used as terms of description and not of limitation, and there is no intention in the use of such terms and expressions of excluding equivalents of the features shown and described, or portions thereof, it being recognized that various modifications are possible within the scope of the invention claimed.

What is claimed is:

1. A method for screening compounds for biological activity comprising:
a) selecting a test library of compounds;
b) forming a first analytical model using a first recursive partitioning process using a digital computer, wherein the first recursive partitioning process is performed on at least some of the compounds in the test library of compounds;
c) forming a second analytical model using a second recursive partitioning process using the digital computer, wherein the second recursive partitioning process is performed on at least some of the compounds in the test library of compounds; and
d) determining a consensus compound set using at least the first analytical model and the second analytical model.

2. The method of claim 1 further comprising:
forming a third analytical model using a third recursive partitioning process using the digital computer, wherein the third recursive partitioning process is performed on at least some of the compounds in the test library of compounds; and
wherein determining the consensus compound set further includes using the third analytical model in addition to the first analytical model and the second analytical model.

3. The method of claim 1 wherein the compounds that are used to form the first and second analytical models are the same.

4. The method of claim 1 wherein the compounds that are used to form the first and the second analytical models are different.

5. The method of claim 1 wherein the compounds that are used to form the first and the second analytical models are the same and constitute a training set of the library of compounds.

6. The method of claim 1 wherein test library of compounds comprise ion channel modulators.

7. The method of claim 1 wherein d) is performed by the digital computer.

8. The method of claim 1 wherein determining the consensus compound set includes identifying compounds that are predicted to be active by both the first analytical model and the second analytical model.

9. A computer readable medium comprising:
a) code for selecting a test library of compounds;
b) code for forming a first analytical model using a first recursive partitioning process using a digital computer, wherein the first recursive partitioning process is performed on at least some of the compounds in the test library of compounds;
c) code for forming a second analytical model using a second recursive partitioning process using the digital computer, wherein the second recursive partitioning process is performed on at least some of the compounds in the test library of compounds; and
d) code for determining a consensus compound set using at least the first analytical model and the second analytical model.

10. The computer readable medium of claim 9 further comprising:
code for forming a third analytical model using a third recursive partitioning process using the digital computer, wherein the third recursive partitioning process is performed on at least some of the compounds in the test library of compounds; and
wherein determining the consensus compound set further includes using the third analytical model in addition to the first analytical model and the second analytical model.

11. The computer readable medium of claim 9 wherein the compounds that are used to form the first and second analytical models are the same.

12. The computer readable medium of claim 9 wherein the compounds that are used to form the first and the second analytical models are different.

13. The computer readable medium of claim 9 wherein the compounds that are used to form the first and the second analytical models are the same and constitute a training set of the library of compounds.

14. The computer readable medium of claim 9 wherein test library of compounds comprise ion channel modulators.

15. The computer readable medium of claim 9 wherein the digital computer is embodied by two or more computational apparatuses.

16. The computer readable medium of claim 9 wherein determining the consensus compound set includes identifying compounds that are predicted to be active by both the first analytical model and the second analytical model.
